(19) United States
(12) Patent Application Publication
(10) Pub. No.: US 2012/0081411 A1
(43) Pub. Date: Apr. 5, 2012

(54) LIQUID CRYSTAL DISPLAY AND SIGNAL TRANSMISSION APPARATUS THEREOF

(76) Inventors: Keng-Yi Lee, Hsin-Chu (TW); Shih-Yao Lin, Hsin-Chu (TW)

(21) Appl. No.: 13/110,000

(22) Filed: May 18, 2011

(30) Foreign Application Priority Data
Sep. 30, 2010 (TW) 099133250

(51) Int. Cl. G09G 5/10

(52) U.S. Cl. 345/690

(57) ABSTRACT

The present invention provides a liquid crystal display, including a liquid crystal panel, a light-source module, and a transmission device. The light-source module includes a light-source circuit board, at least one light-emitting device, and a connector. The light-emitting device is disposed on the light-source circuit board and electrically connected to the light-emitting device through the light-source circuit board. The transmission device is electrically connected to the liquid crystal display and the connector, so that a display signal is transmitted to the liquid crystal panel through the transmission device, and a light-source control signal is transmitted to the light-emitting device sequentially through the transmission device, the connector and the light-source circuit board.

### BACKGROUND OF THE INVENTION

1. Field of the Invention

The present invention relates to a liquid crystal display and a signal transmission apparatus thereof, and more particularly, to a liquid crystal display and a signal transmission apparatus thereof using a connector to transmit a light-source control signal.

2. Description of the Prior Art

The liquid crystal display (LCD) panel is characterized by light weight, low power consumption, and low radiation, and is widely applied in portable electronic products such as notebook computers and personal digital assistant (PDAs). LCD monitors are so useful that cathode ray tube (CRT) monitors are being replaced. It is well known that incident light will produce different polarization or refraction when the alignments of liquid crystal molecules are different. Accordingly, the LCD utilizes the liquid crystal molecules with different alignments to control the light transmittance of each pixel unit, so that the LCD is enabled to produce images.

In liquid crystal display, a liquid crystal panel for displaying the images and a light-source module for generating light are disposed separately, and thus, a display signal and a light-source control signal are respectively transmitted to the liquid crystal panel and the light-source module by a same controller in order to combine the alignments of the liquid crystal molecules with the control of the light. Refer to FIG. 1, which is a schematic diagram illustrating a liquid crystal display according to the prior art. As shown in FIG. 1, the liquid crystal display 10 of the prior art includes a liquid crystal panel 12, a light-source module 14, a conductive adhesive 16, a flexible circuit board 18, and a control circuit board 20. The light-source module 14 includes a plurality of light-emitting devices 22 and a light-source circuit board 24, and the light-source circuit board 24 has a connecting part 26. Due to the connecting part 26, the light-source circuit board 24 has a T-shaped formation. Furthermore, the control circuit board 20 has a connector 28 for being connected to the connecting part 26 of the light-source circuit board 24 so as to transmit the light-source control signal to the light-source circuit board 24, and the light-emitting device 22 can be controlled to generate light. In addition, the conductive adhesive 16 fixes an end of the flexible circuit board 18 on the control circuit board 20, and electrically connects the flexible circuit board and the other end of the flexible circuit board to the control circuit board 20 and the liquid crystal panel 12 respectively, so that the display signal in the control circuit board 20 can be transmitted to the liquid crystal panel 12 through the flexible circuit board 18. Accordingly, the display signal can control the action of the liquid crystal panel 12. For example, the action of the liquid crystal molecules in the liquid crystal panel 12 can be controlled when the control device in the liquid crystal panel 12 is received the display signal, and the liquid crystal molecules are driven to rotate. The rotated liquid crystal molecules are combined with the light of the light-emitting device 22, and the liquid crystal display 10 of the prior art can therefore display images.

However, the light-source circuit board 24 of the prior art requires the connecting part 26 and has the T-shaped formation. Thus, a circuit board material for manufacturing the light-source circuit board 24 with the T-shaped formation cannot be full utilized, and the rest flexible sheet material is wasted. Refer to FIG. 2, which is a schematic diagram illustrating a composition for manufacturing the flexible circuit boards according to the prior art. According to the example as shown in FIG. 2, when the circuit board material is provided with a specific area, the connecting parts 26 of the two adjacent light-source circuit boards 24 should be disposed between the two adjacent light-source circuit boards 24 in order to manufacture the light-source circuit board having the T-shaped formation. Therefore, the provided circuit board material 30 only can be divided into twelve complete light-source circuit boards 24, and a part of the circuit board material 30 between the adjacent light-source circuit boards 24 still is unused, so that utility of the circuit board material 30 is not enough, which results in the problem of waste of materials.

Furthermore, in the liquid crystal display 10 of the prior art, in order to connect to the connecting part 26 of the light-source circuit board 24, the control circuit board 20 disposes the connector 28 to be fixed on and electrically connected to the connecting part 26. Besides, the flexible circuit board 18 for transmitting the display signal further is fixed on and electrically connected to the control circuit board 20 by using the conductive adhesive. For this reason, using two connection assembling methods of the connector 28 and conductive adhesive 16 simultaneously in the control circuit board 20 not only is complicated and difficult but also usually results in damages of the connector 28 or the conductive adhesive 16 during assembling the connection due to the problem of the process sequence, and the manufacturing cost is also increased.

Therefore, to raise the utility of circuit board material for manufacturing the light-source circuit board of the light-source module and to reduce the complication of assembling the flexible circuit board and the light-source circuit board are objectives in this field.

### SUMMARY OF THE INVENTION

It is therefore an objective of the present invention to provide a liquid crystal display and a signal transmission apparatus thereof to raise the utility of circuit board material for manufacturing the light-source circuit board of the light-source module and reduce the complication of assembling the flexible circuit board and the light-source circuit board.

According to a preferred embodiment of the present invention, a liquid crystal display is disclosed. The liquid crystal display includes a liquid crystal panel, a light-source module, and a transmission device. The liquid crystal panel is used for receiving a display signal and displaying an image according the display signal. The light-source module is used for receiving a light-source control signal and emitting light according to the light-source control signal, and the light-source module includes a light-source circuit board, at least one light-emitting device, and a connector. The light-emitting device is disposed on the light-source circuit board, and the connector is disposed on the light-source circuit board and electrically connected to the light-emitting device through the light-source circuit board. The transmission device is electrically connected to the liquid crystal panel and the connector, so that the display signal is transmitted to the liquid crystal panel through the transmission device, and the light-source control signal is transmitted to the light-emitting device sequentially through the transmission device, the connector and the light-source circuit board.

According to a preferred embodiment of the present invention, a signal transmission apparatus of a liquid crystal display is further disclosed. The signal transmission apparatus is used for transmitting a display signal to a liquid crystal panel and transmitting a light-source control signal to a light-source circuit board. The signal transmission apparatus includes a connector and a transmission device. The connector is disposed on the light-source circuit board and electrically connected to at least one light-emitting device through the light-source circuit board. The transmission device is electrically connected to the liquid crystal panel and the connector, so that the display signal is transmitted to the liquid crystal panel through the transmission device, and the light-source control signal is transmitted to the light-source circuit board sequentially through the transmission device and the connector.

The connector is disposed on the light-source circuit board in the liquid crystal display of the present invention, so that the light-source circuit board does not require an extra connecting part being extended to electrically connect the control circuit board. Thus, the light-source circuit board has a strip formation, so that the utility of the circuit board material for manufacturing the light-source circuit board can be effectively raised, and the material cost can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal display according to the prior art.

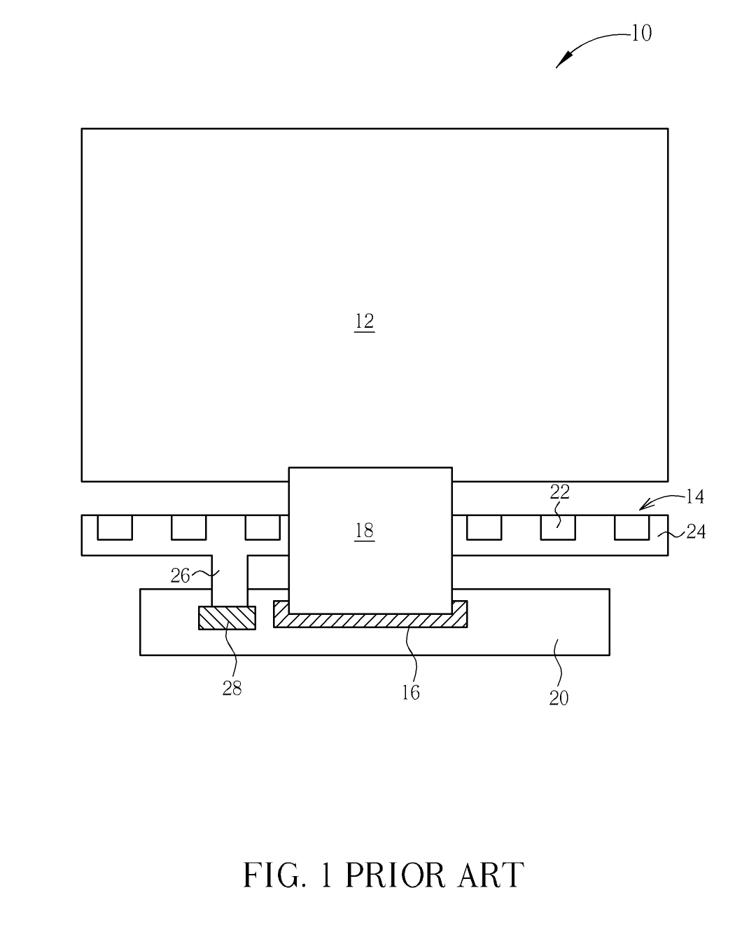

FIG. 2 is a schematic diagram illustrating a composition for manufacturing the flexible circuit boards according to the prior art.

FIG. 3 is a schematic diagram illustrating a liquid crystal display according to a first preferred embodiment of the present invention.

FIG. 4 is a schematic diagram illustrating a composition for manufacturing the light-source circuit boards according to the first preferred embodiment.

FIG. 5 is a schematic diagram illustrating a liquid crystal display according to a second preferred embodiment of the present invention.

### DETAILED DESCRIPTION

To provide a better understanding of the presented invention, preferred embodiments will be made in details. The preferred embodiments of the present invention are illustrated in the accompanying drawings with numbered elements.

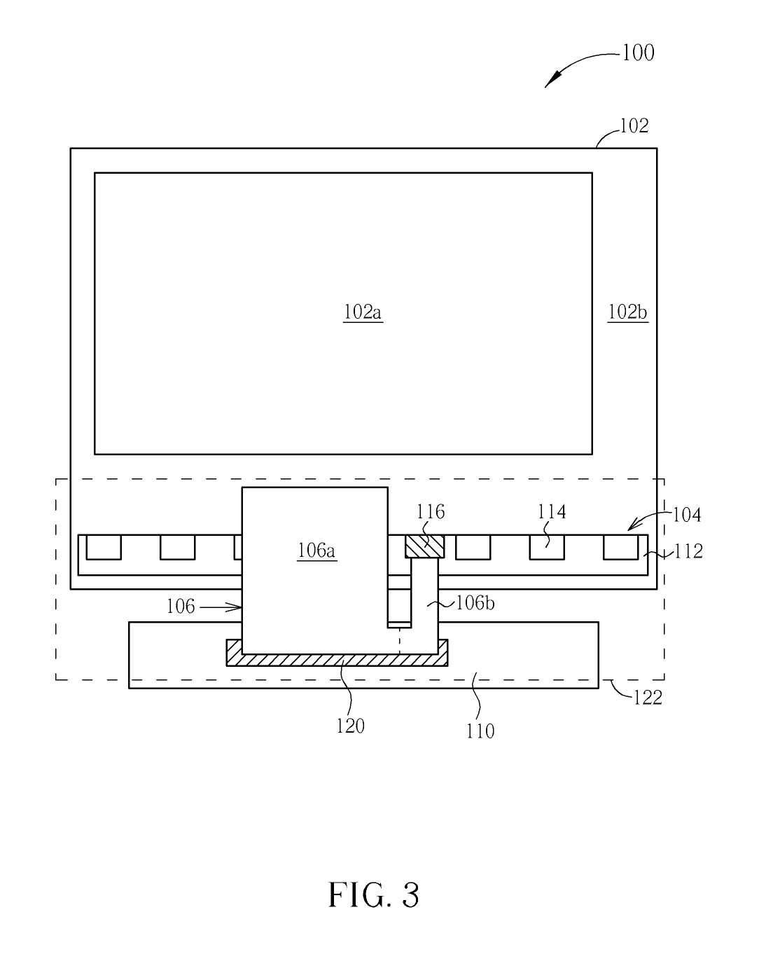

Refer to FIG. 3, which is a schematic diagram illustrating a liquid crystal display according to a first preferred embodiment of the present invention. As shown in FIG. 3, the liquid crystal display 100 of this preferred embodiment includes a liquid crystal panel 102, a light-source module 104, a transmission device 106, and a control circuit board 110. The control circuit board 110 of this preferred embodiment is used for providing a display signal to the liquid crystal panel 102 and providing a light-source control signal to the light-source module 104, and the control circuit board 110 can be a rigid or flexible circuit board having a control system, but is not limited herein. Or, the control circuit board 110 is electrically connected to a control system so as to provide the display signal and the light-source control signal that are synchronized.

The liquid crystal panel 102 includes an array substrate, a color filter substrate, and a plurality of liquid crystal molecules, and the liquid crystal molecules are disposed between the array substrate and the color filter substrate. The liquid crystal panel 102 is used for receiving the display signal and displaying an image according the display signal, and the liquid crystal panel 102 has a display region 102a and a non-display region 102b. In addition, the liquid crystal panel 102 in the non-display region 102b is used to dispose a driving circuit device for driving the liquid crystal panel 102, so that the liquid crystal panel 102 in the display region 102a can display the image. An end of the transmission device 106 is connected to the liquid crystal panel 102 in the non-display region 102b so as to electrically connect the driving circuit device of the liquid crystal panel 102. Accordingly, the display signal can be transmitted to the driving circuit device of the liquid crystal panel 102 and further driving the liquid crystal panel 102.

The light-source module 104 is disposed in the non-display region 102b, and is used for receiving the light-source control signal and emitting light according to the light-source control signal. The light-source module 104 of this preferred embodiment includes a light-source circuit board 112, a plurality of light-emitting devices 114, and a connector 116. Each light-emitting device 114 is disposed and fixed on the light-source circuit board 112, and each light-emitting device 114 is electrically connected to a circuit of the light-source circuit board 112 respectively, so that the light-emitting devices 114 are electrically insulated from each other. The light-emitting devices 114 of present invention are not limited to be electrically insulated from each other, and also can be electrically connected to each other. Or, apart of the light-emitting devices 114 are electrically connected to each other. The light-source module 104 of the present invention is not limited to have a plurality of the light-emitting devices 114, and also can only have one light-emitting device 114. The present invention is not limited herein. In addition, the light-emitting device 114 can be a device capable of producing light, such as a light-emitting diode or an organic light-emitting diode, and is not limited herein. The connector 116 is an electric connector, and the connector 116 is disposed and fixed on the light-source circuit board 112. Furthermore, the connector 116 is electrically connected to the circuit of the light-source circuit board 112, so that the connector 116 can electrically connected to each light-emitting device 114 respectively through the light-source circuit board 112, but the present invention is not limited to this. The connector 116 of the present invention also can be electrically connected to the light-emitting devices 114 together or be electrically connected to different parts of the light-emitting devices 114 respectively. Moreover, the transmission device 106 is electrically connected to the connector 116, and the transmission device 106 is fixed on the connector 116 through a fixing mechanism of the connector 116, so that the light-source control signal can be transmitted to the light-emitting devices 114 sequentially through the transmission device 106, the connector 116 and the light-source circuit board 112. In the present invention, the method of the connector 116 fixing the transmission device 106 can be a method of inserting the transmission device 106 into the connector 116 or utilizing a tenon or a cover to fix the transmission device 106, and is not limited herein. In this preferred embodiment, the connector 116 is disposed on the light-source circuit board 112, so that the light-source circuit board 112 does not require an extra connecting part being extended to electrically connect the control circuit board 110. Thus, the light-source circuit board 112 in this embodiment has a strip formation. Furthermore, the light-source circuit board 112 in this preferred embodiment can be a flexible circuit board, a rigid printed circuit board or a flexible printed circuit board, and is not limited to these.

As the above-mentioned description, the liquid crystal display 100 of this preferred embodiment has a signal transmission apparatus 122 used for transmitting the display signal from the control circuit board 110 to the liquid crystal panel 102 and transmitting the light-source control signal from the control circuit board 110 to the light-source circuit board 112. The signal transmission apparatus 122 includes the connector 116 and the transmission device 106. When the display signal and the light-source control signal are generated from the control circuit board 110, the display signal can be transmitted to the liquid crystal panel 102 through the transmission device 106 of the signal transmission apparatus 122, and the light-source control signal can be transmitted to the light-source circuit board 112 through the transmission device 106 and the connector 116 of the signal transmission apparatus 122.

In this preferred embodiment, the transmission device 106 is a flexible circuit board, and for example is a flexible circuit board composed of a single sheet. The transmission device 106 includes a first transmission part 106a and a second transmission part 106b. An end of the first transmission part 106a is connected to the liquid crystal panel 102, and an end of the second transmission part 106b is connected to the connector 116. Accordingly, the first transmission part 106a can be electrically connected to the liquid crystal panel 102, and the display signal can be transmitted to the liquid crystal panel 102 through the first transmission part 106a. The second transmission part 106b can be electrically connected to the connector 116, and the light-source control signal can be transmitted to the light-emitting device 114 sequentially through the second transmission part 106b, the connector 116 and the light-source circuit board 112.

In addition, the liquid crystal display 100 further includes a conductive adhesive 120, adhering to the control circuit board 110, and the conductive adhesive 120 is used for connecting the transmission device 106 to the control circuit board 110. The conductive adhesive 120 can include a material having both a conductive property and an adhesive property, such as an anisotropic conductive film (ACF). For this reason, the conductive adhesive 120 not only can connect the transmission device 106 to the control circuit board 110 but also electrically connect the transmission device 106 to the control circuit board 110. Thus, the first transmission part 106a and the second transmission part 106b of the transmission device 106 can be combined with and electrically connected to the control circuit board 110 by the conductive adhesive 120, and the control circuit board 110 can be electrically connected to the liquid crystal panel 102 through the first transmission part 106a and electrically connected to the light-source module 104 through the second transmission part 106b of the transmission device 106. Furthermore, the display signal can be transmitted to the liquid crystal panel 102 through the first transmission part 106a, and the light-source control signal can be transmitted to the light-source module 104 through the second transmission part 106b. It should be noted that the liquid crystal display 100 in this preferred embodiment only divides one transmission device 106 into the first transmission part 106a and the second transmission part 106b to be electrically connected to the liquid crystal panel 102 and the connector 116 respectively, and the control circuit board 110 therefore does not require an extra connector to connect a connecting part of the light-source circuit board for transmitting the light-source control signal. In this preferred embodiment, the control circuit board 110 only requires disposing the conductive adhesive 120 on it to connect to the transmission device 106, so that the transmission device 106 can be fixed on the control circuit board 110, and the transmission device 106 can be electrically connected to the control circuit board 110 simultaneously. Accordingly, the liquid crystal display 100 of this preferred embodiment can save the step of inserting the connecting part of the light-source circuit board of the prior art into the extra connector of the control circuit board of the prior art. Therefore, not only the cost of the connector of the control circuit board of the prior art can be saved, but also the manufacturing cost can be reduced.

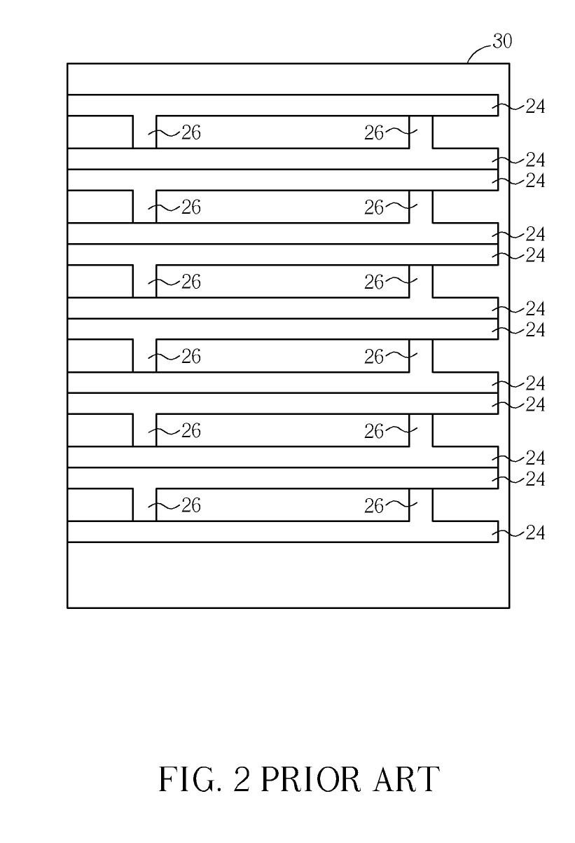

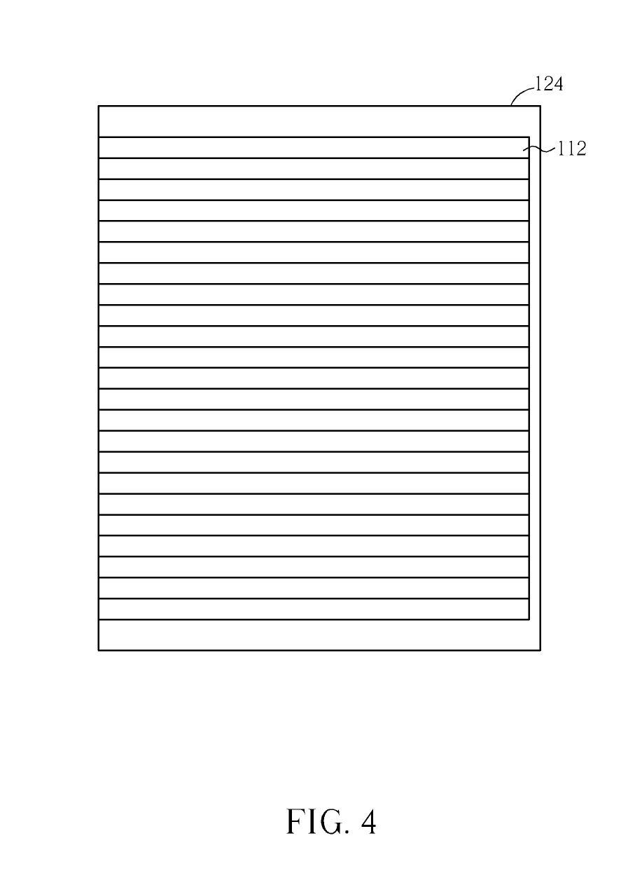

It should be noted that the light-source circuit board 112 has a strip formation. Accordingly, the utility of the circuit board material for manufacturing the light-source circuit board 112 can be raised, and the manufacturing cost can be reduced. Refer to FIG. 4 together with FIG. 2. FIG. 4 is a schematic diagram illustrating a composition for manufacturing the light-source circuit boards according to the first preferred embodiment. As shown in FIG. 4, when a circuit board material 124 is provided to have the same area as the circuit board material of the light-source circuit board of the prior art, the circuit board material 124 can be divided into twenty five strip-shaped light-source circuit boards 112. For this reason, as compared with manufacturing the light-source circuit board of the prior art, the composition number of the light-source circuit boards 112 in this preferred embodiment is larger than the composition number of the light-source circuit boards with T-shaped formation of the prior art when the provided circuit board material 124 has the same area. Thus, the design of the light-source circuit board 112 in this preferred embodiment can effectively raise the utility of the circuit board material 124 for manufacturing the light-source circuit board 112 and reduce the material cost. Furthermore, the transmission device 106 of the present invention is not limited that a distance is between the first transmission part 106a and the second transmission part 106b, and the first transmission part 106a and the second transmission part 106b are in the L-shaped formation, as shown in FIG. 3. In the present invention, the first transmission part 106a and the second transmission part 106b of the transmission device 106 also can be in the rectangular formation, and a part of a side of the first transmission part 106a is in contact with the a part of a side of the second transmission part 106b. Accordingly, the transmission device 106 composed of the first transmission part 106a and the second transmission part 106b can be in a rectangular formation and have a preferable utility of the transmission device 106. As compared with the prior art, the transmission device 106 of the present invention does not reduce the utility in composing the transmission devices 106 when the first transmission part 106a is integrated with the second transmission part 106b.

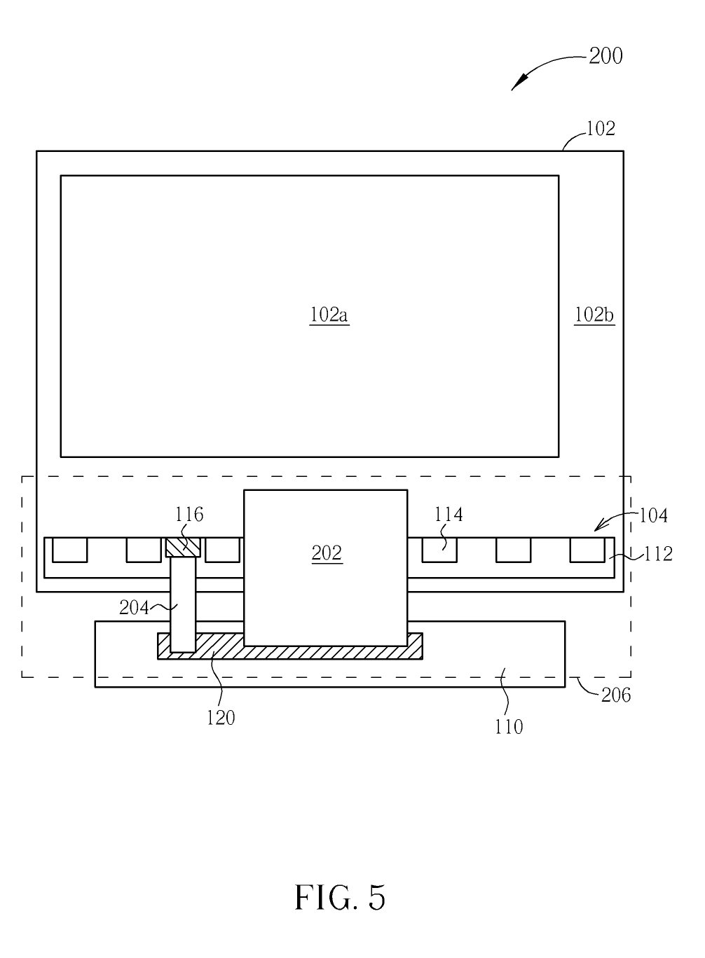

Besides, the liquid crystal display of the present invention is not limited to the above-mentioned liquid crystal display using the same flexible circuit board to transmit the display signal and the light-source control signal, and also can use two flexible circuit boards to respectively transmit the display signal and the light-source control signal. The following description continues to detail the other embodiments or modifications, and in order to simplify and show the difference between the other embodiments or modifications and the above-mentioned embodiment, the same numerals denote the same components in the following description, and the same parts are not detailed redundantly. Refer to FIG. 5, which is a schematic diagram illustrating a liquid crystal display according to a second preferred embodiment of the present invention. As shown in FIG. 5, as compared with the first preferred embodiment, the transmission device 106 of the liquid crystal display 200 includes a first flexible circuit board 202 and a second flexible circuit board 204 in the second preferred embodiment, and the first flexible circuit board 202 is not in contact with the second flexible circuit board 204. Furthermore, the first flexible circuit board 202 is electrically connected between the liquid crystal panel 102 and the control circuit board 110, and the display signal can be transmitted to the liquid crystal panel 102 through the first flexible circuit board 202. The second flexible circuit board 204 is electrically connected between the connector 116 and the control circuit board 110, and the light-source control signal can be transmitted to the light-emitting device 114 sequentially through the second flexible circuit board 204, the connector 116 and the light-source circuit board 112. Accordingly, the first flexible circuit board 202 and the second flexible circuit board 204 can respectively transmit the provided display signal and the provided light-source control signal to the liquid crystal panel 102 and the light-source module 104. In addition, the conductive adhesive 120 of the liquid crystal display 200 can connect the first flexible circuit board 202 and the second flexible circuit board 204 to the control circuit board 110 together in this preferred embodiment, so that the first flexible circuit board 202 can be electrically connected to the control circuit board 110, and the second flexible circuit board 204 can be electrically connected to the control circuit board 110. It should be noted that although the first flexible circuit board 202 for transmitting the display signal and the second flexible circuit board 204 for transmitting the light-source control signal are separated in the liquid crystal display 200 of this preferred embodiment, the conductive adhesive that is disposed on the control circuit board 110 can simultaneously fix the first flexible circuit board 202 and the second flexible circuit board 204 on the control circuit board 110 and electrically connect the first flexible circuit board 202 and the second flexible circuit board 204 to the control circuit board 110. Accordingly, the step of inserting the connecting part of the light-source circuit board of the prior art into the extra connector of the control circuit board of the prior art can be saved, and the manufacturing cost can be reduced. In addition, in order to easily fix the first flexible circuit board 202 and the second flexible circuit board 204 on the control circuit board 110, the control circuit board 110 can be first marked to have regions respectively defining the first flexible circuit board 202 and the second flexible circuit board 204 in this preferred embodiment, so that the first flexible circuit board 202 and the second flexible circuit board 204 can be simultaneously fixed on the control circuit board 110 through the conductive adhesive 120 in a same process.

In summary, the connector is disposed on the light-source circuit board in the liquid crystal display of the present invention, so that the light-source circuit board does not require an extra connecting part being extended to electrically connect the control circuit board. Thus, the light-source circuit board has a strip formation, so that the utility of the circuit board material for manufacturing the light-source circuit board can be effectively raised, and the material cost can be reduced. In addition, the control circuit board only requires disposing the conductive adhesive on it in the liquid crystal display of the present invention, so that the transmission device can be fixed on the control circuit board, and the transmission device can be electrically connected to the control circuit board simultaneously. Accordingly, the step of inserting the connecting part of the light-source circuit board of the prior art into the extra connector of the control circuit board of the prior art can be saved, and the manufacturing cost also can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display, comprising:
a liquid crystal panel for receiving a display signal and displaying an image according to the display signal;
a light-source module for receiving a light-source control signal and emitting light according to the light-source control signal, the light-source module comprising:
a light-source circuit board;
at least one light-emitting device, disposed on the light-source circuit board; and
a connector, disposed on the light-source circuit board and electrically connected to the light-emitting device through the light-source circuit board; and
a transmission device, electrically connected to the liquid crystal panel and the connector, so that the display signal is transmitted to the liquid crystal panel through the transmission device, and the light-source control signal is transmitted to the light-emitting device sequentially through the transmission device, the connector and the light-source circuit board.

2. The liquid crystal display according to claim 1, further comprising a control circuit board, electrically connected to the transmission device and used for providing the display signal to the liquid crystal panel and the light-source control signal to the light-source module.

3. The liquid crystal display according to claim 2, wherein the transmission device is a flexible circuit board, and the flexible circuit board comprises:
a first transmission part, electrically connected to the liquid crystal panel, and the display signal being transmitted to the liquid crystal panel through the first transmission part; and
a second transmission part, electrically connected to the connector, and the light-source control signal being transmitted to the light-emitting device sequentially through the second transmission part, the connector and the light circuit board.

4. The liquid crystal display according to claim 3, further comprising a conductive adhesive, connecting the flexible circuit board to the control circuit board, and electrically connecting the flexible circuit board to the control circuit board.

5. The liquid crystal display according to claim 4, wherein the conductive adhesive comprises an anisotropic conductive film (ACF).

6. The liquid crystal display according to claim 2, wherein the transmission device comprises:
a first flexible circuit board, electrically connected between the liquid crystal panel and the control circuit board, and the display signal being transmitted to the liquid crystal panel through the first flexible circuit board; and
a second flexible circuit board, electrically connected between the connector and the control circuit board, and the light-source control signal being transmitted to the light-emitting device sequentially through the second flexible circuit board, the connector and the light-source circuit board.

7. The liquid crystal display according to claim 6, further comprising a conductive adhesive, connecting the first flexible circuit board and the second flexible circuit board to the control circuit board, and the conductive adhesive electrically connecting the first flexible circuit board to the control circuit board and electrically connecting the second flexible circuit board to the control circuit board.

8. The liquid crystal display according to claim 2, further comprising a conductive adhesive, adhering to the control circuit board, and the transmission device being electrically connected to the control circuit board only through the conductive adhesive.

9. A signal transmission apparatus of a liquid crystal display for transmitting a display signal to a liquid crystal panel and transmitting a light-source control signal to a light-source circuit board, the signal transmission apparatus comprising:
a connector, disposed on the light-source circuit board, and electrically connected to at least one light-emitting device through the light-source circuit board; and
a transmission device, electrically connected to the liquid crystal panel and the connector, so that the display signal is transmitted to the liquid crystal panel through the transmission device, and the light-source control signal is transmitted to the light-source circuit board sequentially through the transmission device and the connector.
